(19) United States
(12) Patent Application Publication
(10) Pub. No.: US 2010/0250306 A1
(43) Pub. Date: Sep. 30, 2010

(54) System and method to determine root cause constraints and resolution options to solve order promising exceptions

(76) Inventors: Deepak Sanghi, Bangalore (IN); Alok Ashtikar, Bangalore (IN); Nitin Gupta, Jaipur (IN); Toolika Maria Lewis, Bangalore (IN); Sachin Maheshwari, Lucknow (IN); Arvindh Murugan, Flower Mound, TX (US)

Correspondence Address: Booth Udall, PLC, 1155 W Rio Salado Parkway, Suite 101, Tempe, AZ, 85281, US

(21) Appl. No.: 12/569,813

(22) Filed: Sep. 29, 2009

Related U.S. Application Data
(60) Provisional application No. 61/101,954, filed on Oct. 1, 2008.

(51) Int. Cl. G06Q 10/00; G06Q 50/00

(52) U.S. Cl. 705/7; 705/348; 705/28

(57) ABSTRACT

A system and method is disclosed for determining root cause constraints and resolution options to solve order promising exceptions. The system includes a database storing order promise data associated with one or more enterprises. The system further includes a computer coupled with the database, the computer is configured to receive an order promise from the one or more enterprises, define one or more constraints, and create one or more strategy models comprising one or more strategy changes. The computer is further configured to execute the one or more strategy models to relax the one or more constraints using the one or more strategy changes and generate a report of the reasons for lateness and shortness of the order promise and store the generated report in the database.

### TECHNICAL FIELD OF THE INVENTION

This invention relates generally to order promising, and more particularly to system and method to determine root cause constraints and resolution options to solve order promising exceptions.

### BACKGROUND OF THE INVENTION

Traditional order promising solutions have primarily dealt with generating an optimal demand commit response given specific demand, product or enterprise requirements. However, one of the shortcomings of the traditional order promising solutions is that when an order is shorted or delayed there isn't a mechanism to understand the reasoning of the shorted or lated order. The problem is further compounded when real time responses are generated to commit supply to incoming demand since the time to analyze and react to mismatches between the demand requirements and responses is significantly small. This inability to provide a mechanism to understand the reasoning of the shorted or lated/delayed order is undesirable.

### SUMMARY OF THE INVENTION

A system providing an order promising system is disclosed. The system includes a database storing order promise data associated with one or more enterprises. The system further includes a computer coupled with the database, the computer is configured to receive an order promise from the one or more enterprises, define one or more constraints, and create one or more strategy models comprising one or more strategy changes. The computer is further configured to execute the one or more strategy models to relax the one or more constraints using the one or more strategy changes and generate a report of the reasons for lateness and shortness of the order promise and store the generated report in the database.

A method providing an order promising system is disclosed. The method provides for receiving, by a computer, an order promise from one or more enterprises, defining, by the computer, one or more constraints, and creating, by the computer, one or more strategy models comprising one or more strategy changes. The method further provides for executing, by the computer, the one or more strategy models to relax the one or more constraints using the one or more strategy changes and generating, by the computer, a report of the reasons for lateness and shortness of the order promise and store the generated report.

A computer-readable medium embodied with software enabling an order promising system is disclosed. The computer-readable medium receives an order promise from one or more enterprises, defines one or more constraints, and creates one or more strategy models comprising one or more strategy changes. The computer-readable medium further executes the one or more strategy models to relax the one or more constraints using the one or more strategy changes and generates a report of the reasons for lateness and shortness of the order promise and store the generated report.

### BRIEF DESCRIPTION OF THE DRAWINGS

The novel features believed characteristic of the invention are set forth in the appended claims. However, the invention itself, as well as a preferred mode of use, and further objectives and advantages thereof, will best be understood by reference to the following detailed description when read in conjunction with the accompanying drawings, wherein:

FIG. 1 illustrates an exemplary system in accordance with a preferred embodiment;

FIG. 2 illustrates the order promising system of FIG. 1 in greater detail in accordance with the preferred embodiment;

FIG. 3 illustrates an exemplary system comprising two options for delivery services including air transportation mode and road transportation mode in accordance with an embodiment;

FIG. 4 illustrates an exemplary location in accordance with an embodiment;

FIG. 5 illustrates an exemplary method of determining constraints and resolution options to solve order promising exceptions; and

FIG. 6 illustrates an exemplary method of generating a reasons and resolutions report.

### DETAILED DESCRIPTION OF THE INVENTION

Reference will now be made to the following detailed description of the preferred and alternate embodiments. Those skilled in the art will recognize that the present invention provides many inventive concepts and novel features, that are merely illustrative, and are not to be construed as restrictive. Accordingly, the specific embodiments discussed herein are given by way of example and do not limit the scope of the present invention.

FIG. 1 illustrates an exemplary system 100 according to a preferred embodiment. System 100 comprises order promising system 110, one or more enterprises 120a-120n, one or more customers 130a-130n, a network 140, and communication links 142, 144a-144n and 146a-146n. Although a single order promising system 110, one or more enterprises 120a-120n, and one or more customers 130a-130n, are shown and described; embodiments contemplate any number of order promising systems 110, any number of enterprises 120a-120n, and/or any number of customers 130a-130n, according to particular needs. In addition, or as an alternative, order promising system 110 may be integral to or separate from the hardware and/or software of any one of the one or more enterprises 120a-120n.

In one embodiment, order promising system 110 determines root cause constraints and resolution options to solve order promising exceptions. In addition, or as an alternative, order promising system 110 allows one or more enterprises 120a-120n to prioritize and choose a hierarchy of strategies to analyze and resolve order promising exceptions for one or a set of orders. That is, in orders where the responses do not align with the requirements specified in the demand or the supply/allocations available in the supply chain at the time of analysis. As an example only and not by way of limitation, order promising system 110 may relax, for example, allocation, lateness and sourcing constraints in that order for one deployment, while order promising system 110 may relax minimum quantity and supply constraints, for a different deployment. The approach is therefore designed to each deployment, in such a way as to relax specific constraints that can be modified in the interest of gaining high priority demands, from one or more customers 130a-130n, in order to negotiate an agreeable commit response to these high priority demands.

In another embodiment, one or more enterprises 120a-120n may use one or more hierarchical strategies to analyze one or a set of orders, to simulate the potential answer on, for example, a graphical user interface, should the constraint be relaxed in a hierarchical manner keeping in place “hard” demand requirements clearly identifying some of the root causes in the model that contribute to the mismatched response and finally guide the user to utilize actions should he choose to use the relaxed constraints to modify the mismatched responses.

In one embodiment, the system may operate on one or more computers that may be integral to, or separate from, the hardware and/or software that support order promising system 110, one or more enterprises 120a-120n, and one or more customers 130a-130n. These one or more computers may include any suitable input device, such as a keypad, mouse, touch screen, microphone, or other device to input information. In addition, these one or more computers may include any suitable output device that may convey information associated with the operation of system 100, including digital or analog data, visual information, or audio information. Furthermore, these one or more computers may include fixed or removable computer-readable storage media, such as magnetic computer disks, CD-ROM, or other suitable media to receive output from and provide input to system 100. In addition, these one or more computers may include one or more processors and associated memory to execute instructions and manipulate information according to the operation of system 100.

In addition, or as an alternative, order promising system 110, one or more enterprises 120a-120n, and/or one or more customers 130a-130n may each operate on one or more separate computers or may operate on one or more shared computers. Each of these one or more computers may be a work station, personal computer (PC), network computer, personal digital assistant (PDA), wireless data port, or any other suitable computing device. In another embodiment, one or more users may be associated with order promising system 110, one or more enterprises 120a-120n, and one or more customers 130a-130n. These one or more users may include, for example, a “planner” handling order promising and/or one or more related tasks within system 100. In addition, or as an alternative, these one or more users may include, for example, one or more computers programmed to autonomously handle order promising, order fulfillment, supply chain planning and/or one or more related tasks within system 100.

In one embodiment, order promising system 110 may be coupled with network 140 using communications link 142, which may be any wireline, wireless, or other link suitable to support data communications between order promising system 110 and network 140 during operation of system 100. One or more enterprises 120a-120n may be coupled with network 140 using communications link 144a-144n, which may be any wireline, wireless, or other link suitable to support data communications between one or more enterprises 120a-120n and network 140 during operation of system 100. One or more customers 130a-130n may be coupled with network 140 using communications links 146a-146n, which may be any wireline, wireless, or other link suitable to support data communications between one or more customers 130a-130n and network 140 during operation of system 100.

Although communication links 142, 144a-144n and 146a-146n are shown as generally coupling order promising system 110, one or more enterprises 120a-120n, and one or more customers 130a-130n to network 140, order promising system 110, one or more enterprises 120a-120n, and one or more customers 130a-130n may communicate directly with each other, according to particular needs. In addition, or as an alternative, order promising system 110 may reside within one or more enterprises 120a-120n, according to particular needs.

In another embodiment, network 140 may include the Internet and any appropriate local area networks (LANs), metropolitan area networks (MANS), or wide area networks (WANs) coupling order promising system 110, one or more enterprises 120a-120n, and one or more customers 130a-130n. Those skilled in the art will recognize that the complete structure and operation of communication network 140 and other components within system 100 are not depicted or described. Embodiments may be employed in conjunction with known communications networks and other components.

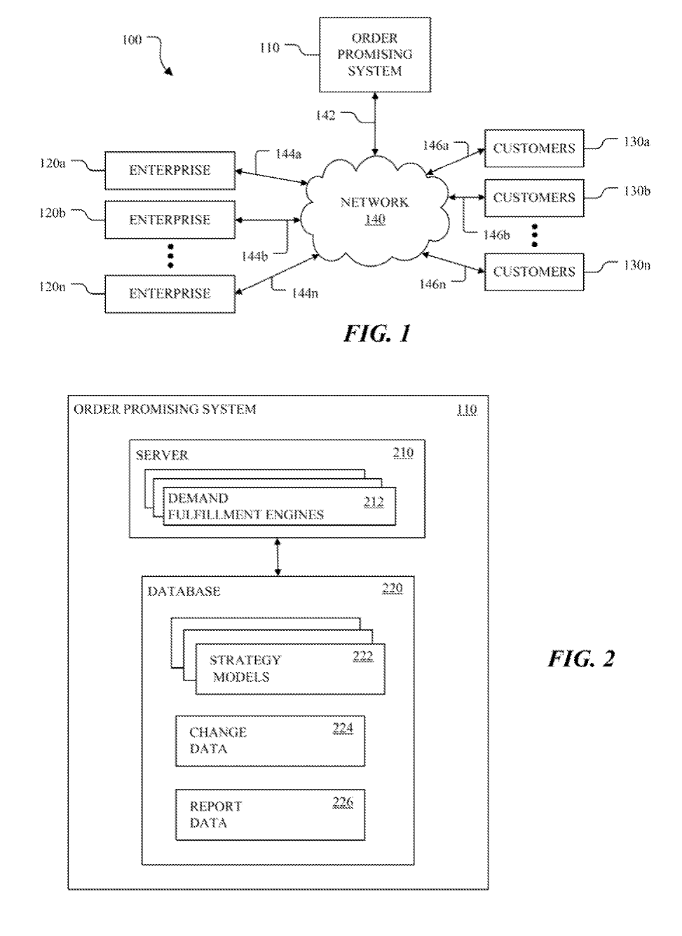

FIG. 2 illustrates order promising system 110 of FIG. 1 in greater detail in accordance with the preferred embodiment. As discussed above, order promising system 110 comprises one or more computers at one or more locations including associated input devices, output devices, computer-readable storage media, processors, memory, or other components for receiving, processing, storing, and communicating information according to the operation of system 100. In one embodiment, order promising system 110 receives, processes, stores, and communicates strategy data associated with one or more enterprises 120a-120n and/or one or more customers 130a-130n, in database 220.

Server 210 comprises one or more demand fulfillment engines 212. Although server 210 is shown and described as comprising one or more demand fulfillment engines 212, embodiments contemplate any suitable optimizers, workflows, order promising engines, engines or combination of engines, according to particular needs.

In one embodiment, demand fulfillment engines 212, may short or delay an order depending upon the supply, allocation and/or supply chain constraints. As an example only and not by way of limitation, the supply chain constraints include (but are not limited to) the following:
1. Order quantity less than the minimum quantity that can be shipped. In this case, the entire order will be shorted even if there is sufficient supply and allocation.
2. Order quantity not in the multiples of the lot size of the shipment. In this case, the order will be shorted (assuming that the promising policy on the order allowed for partial shipments).
3. Order requested for delivery from specific location (plant, warehouse, distribution center, or other specific location). In this case, the order may be shorted or delayed if sufficient supply and allocation don not exist at the chosen location(s).
4. Order requested for specific mode of transportation. In this case, the shipment can be made only from locations that offer the selected mode of transportation and may limit the options that the engine has in fully satisfying the order or satisfying the order on time.

In addition, or as an alternative, some of the above constraints may be hard constraints and may be non-negotiable, while others may be flexible constraints. In addition, the flexible constraints may be the reasons for sub-optimal promises and may be relaxed in, for example, the case of high priority orders.

In another embodiment, demand fulfillment engine 212 considers only the reasons (supply chain constraints) that can be relaxed. If, for example, the shipment lot sizes (supply chain constraint) cannot be changed, then this constraint is not provided to demand fulfillment engine 212 and demand fulfillment engine 212 does not determine if relaxing this constraint may provide a better promise.

Database 220 comprises one or more databases or other data storage arrangements at one or more locations, local to, or remote from, server 210. Database 220 includes, for example, one or more strategy models 222, change data 224, and report data 226. As an example only and not by way of limitation, order promising system 110 stores order promise data associated with one or more enterprises 120a-120n and one or more customers 130a-130n that may be used by server 210, and in particular, by one or more demand fulfillment engines 212.

In addition, the a user associated with order promising system 110 may specify the constraints that demand fulfillment engines 212 should consider while calculating the reasons through one or more strategy models 222. Demand fulfillment engines 212 comprises one or more strategy models and the user can provide the strategy that demand fulfillment engines 212 should use while calculating the Reasons and Resolution report, discussed below in more detail.

In one embodiment, one or more strategy models 222 define the types of constraints demand fulfillment engines 212 considers while generating the Reasons and Resolution report. In addition, the strategy may be defined during the design phase and may depend on all the changes that the user is empowered to make in order to improve the promise of an order. As discussed above, if the user cannot change the shipment lot sizes, there is no point in demand fulfillment engines 212 generating a report with that as a reason because it is a time consuming calculation. In addition, or as an alternative, demand fulfillment engines 212 may specify a specific strategy of the one or more strategy models 222 to use while generating the Reasons and Resolution report for the order(s) that a user is interested in.

In one embodiment, each strategy model 222 includes change data 224 (i.e., one or more changes described below in more detail) that one or more demand fulfillment engines 212 considers in a defined sequence.

In one embodiment, relax minimum quantity (Relax_Min_Quantity) change relaxes the minimum shipment quantity. In essence, the minimum quantity is the minimum quantity that one or more enterprises 120a-120n may ship in any delivery. If, for example, the requested quantity is smaller than the minimum quantity, then the order cannot be promised. In addition, or as an alternative, the minimum quantity is modeled on a sales order line, a product (root) and delivery lanes. In addition, this change in the strategy relaxes all these minimum quantities for the sales order.

As an example only and not by way of limitation, an order for 30 units of an item is due on day 1 with as-soon-as-possible (ASAP) promising policy. In this example, the supply is 12 units on day 1 and 12 units on day 5. The minimum quantity on sales order line is 10 units and on product root is 20 units. The promise of the order will be 10 units on day 1 and 10 units on day 5 and the remaining 10 units will be shorted. When demand fulfillment engines 212 runs this strategy 12 units can be promised on day 1 and 12 units on day 5 and remaining 6 units will be shorted. In this case, the sales order will be changed to set the minimum quantity to −1 and the order will be repromised. This ensures that for this order, the minimum quantity is not considered.

In another embodiment, relax quote multiple (Relax_Quote_Multiple) change relaxes the shipment lot size on the order line. In this change, any delivery quantity may only be in the multiples of quote multiple. If, for example, the quote multiple is 10 units and the requested quantity is 15 units, then the order will be shorted. The quote multiple is modeled on a sales order line, product (root) and delivery lanes. This change in the strategy relaxes all these quote multiples and the order may then be promised without any restrictions on delivery quantity.

As an example only and not by way of limitation, an order for 80 units of an item is due on day 1 with ASAP promising policy. The supply is 25 units on day 1 and 10 units on day 5. The quote multiple on sales order line, product and delivery lane are 20, 40 and 30 units, respectively. The promise of the order will be 20 units on day 1 and the remaining 60 units will be shorted. When demand fulfillment engines 212 runs this strategy with relax quote multiple change, it provides that 25 units can be promised on time on day 1, 10 units on day 5 and the remaining 45 units will be shorted. In this case, the order will be changed to have quote multiple of −1 and the order will be repromised.

In another embodiment, relax pick pack time (Relax_Pick_Pack_Time) change relaxes the pick-pack time on the order line. The pick pack time is an additional time modeled on sales order line. This time is added to the pick pack times modeled at the product (root) and the delivery lane and hence can delay the order. Relaxing this constraint symbolizes an expedited handling of the material. However, unlike minimum quantity and quote multiple changes, the pick pack times are added and therefore relaxing this constraint does not override the pick pack times at the product and delivery lane.

As an example only and not by way of limitation, an order for 20 units is due on day 1 with ASAP promising policy. The supply is 100 units on day 1. The pick pack times at sales order line, product (root) and delivery lane are 3 days, 2 days and 1 day, respectively. The promise of the order will be 20 units on day 6 (adding up all three pick pack times). When demand fulfillment engines 212 runs this strategy with the relax pick pack time change, it provides that the units can be promised on day 3. In this case, the pick pack time will be removed from the sales order line and the order will be repromised.

In another embodiment, relax maximum edges (Relax_Max_Edges) change relaxes the number of shipment legs and it makes multi-hop deliveries possible. The maximum edges on the sales order line provides the maximum transportation legs the delivery for this line can take. Among other things, this signifies the shipment costs associated with satisfying the order. If the maximum number of legs is more, the order may get the supply from supply sources which don't ship directly to the customer. Relaxing this constraint symbolizes the willingness to take higher shipment cost in order to satisfy the customer. In addition, each order line specifies the maximum shipment legs (edges) that the delivery for that order line may take. If, for example, the max_edges on the order line is set to 1, the delivery has to be direct from the location where supply is consumed to the customer's destination.

As an example only and not by way of limitation, an order for 20 units is due on day 1 with ASAP promising policy. The supply at location 1 and location 2 are 10 units each on day 1. The destination for order is distribution center 2. The lanes are from location 1→distribution center 1→distribution center 2 and from location 2→distribution center 2. The maximum edges on the sales order line is 1. In this example, the promise of the order will be 10 units on day 1 from location 2. When demand fulfillment engines 212 runs this strategy, it provides that additional 10 units can be promised on day 1 from location 1. In this case, the maximum edges are set to default (a very high number) in the sales order line and the order will be repromised.

In another embodiment, relax permitted delivery zones (Relax_Permitted_Delivery Zones) change relaxes this constraint and allows demand fulfillment engines 212 to consider all the shipment points for final delivery to the customer. The sales order line specifies the shipping locations from where the final shipment to the customer may take place, referred to as delivery zones. Relaxing this constraint removes the list of permitted delivery zones from the sales order and provides the promise without this constraint. In addition, each order line specifies the shipment point(s) from where the final delivery to the customer should happen.

As an example only and not by way of limitation, an order for 20 units is due on day 1 with ASAP promising policy. The supply at location 1 is 20 units. The delivery lanes are location 1→distribution center 1, location 1→distribution center 1→distribution center 2 (takes 1 day). The shipment is permitted only from distribution center 2. The promise of the order will be 20 units on day 2, with material shipped from location 1 to distribution center 1 and from distribution center 1 to distribution center 2 When demand fulfillment engines 212 runs this strategy is run, it provides that the order can be promised on time on day 1 if the shipment happens from location 1 to distribution center 1 to one or more customers 130a-130n. In this case, the permitted delivery zones of the order will be removed and the order will be repromised.

In another embodiment, relax permitted delivery sources (Relax Permitted Delivery Sources) change allows demand fulfillment engine 212 to consider all possible supply sources. The sales order line may specifies the sources from where the supply must be consumed. These sources are referred to as delivery sources. Relaxing this constraint removes the list of delivery sources from the sales order and allows demand fulfillment engine 212 to look for supply at all possible sources. In addition, each order line can specify the location from where the supply is to be consumed.

As an example only and not by way of limitation, an order for 20 units is due on day 1 with ASAP promising policy. The supply at location 1 is 10 units and at location 2 is 10 units. The list of delivery sources at the sales order line contains only location 1. The promise of order will be 10 units on day 1 from location 1. When demand fulfillment engines 212 runs this strategy, it provides that the order can be promised on time on day 1 if the supply is also consumed from location 2. In this case, the permitted delivery sources of the order are removed and the order will be repromised.

In another embodiment, relax permitted delivery services (Relax Permitted Delivery Services) change allows demand fulfillment engine 212 to consider all possible transportation modes to improve the promise. The sales order line specifies the transportation mode to be used to ship the order. Relaxing this constraints allows demand fulfillment engine 212 to use a faster transportation mode or allows other sources and zones that have a different transportation mode than chosen by the user. In addition, each order line can specify the transportation modes that the shipment should use.

As an example only and not by way of limitation, an order for 20 units is due on day 2 with ASAP promising policy. The destination of the order is distribution center 1. There are two transportation modes from location 1 to distribution center 1: air transportation mode that takes 1 day and road transportation mode that takes 2 days. The list of delivery services contains only the road transportation mode. There is supply of 20 units at location 1 on day 1. The promise of the order will be 20 units on day 3 (1 day late) from location 1 using the road transportation mode. When demand fulfillment engines 212 runs this strategy, it provides that the order can be promised on time using the air transportation mode. In this case, the permitted delivery services of the order are removed and the order will be repromised.

In another embodiment, relax permitted matching products (Relax_Permitted_Matching_Products) change allows demand fulfillment engines 212 to use all the products that the requested item is linked with to satisfy the order. The sales order line specifies a list of different products from where the supply may be consumed. In other words, the order line specifies the products from where the supply should be taken to satisfy the order. In demand fulfillment engine 212, there may not be any relation between the requested item and the list of products specified in the order. When demand fulfillment engines 212 relaxes this constraint, one or more demand fulfillment engines 212 may be able to improve the promise of the order by consuming from all the products that the item is mapped to.

In another embodiment, report allocation shortage (Report_Allocation_Shortage) change relaxes all the allocations and allows the order to consume from the supply directly. If the supply is not allocated to the seller from where the order can consume then the order will not get the optimal promise. This may happen only if there is a supply and the Reasons and Resolution report discussed below, provides the allocations that are available elsewhere that can be used to satisfy the order. In addition, this change reports the extra promise an order receives provided some supply that is allocated to other sellers is made available to the seller where the order is placed. This change only reports the allocation shortages and the allocations will have to be moved before repromising the order to solve the problem.

As an example only and not by way of limitation, an order for 25 units is placed at seller 1 and is due on day 1. The supply is 10 units on day 1 (week 1) and 10 units on day 2 (week 2). This supply is allocated to seller 1 (5 units in week 1 and 5 units in week 2) and seller 2 (5 units in week 1 and 5 units in week 2). The promise of the order will be 5 units on day 1 and 5 units on day 8. When demand fulfillment engines 212 runs this strategy, it provides that extra 5 units can be promised on day 1 and on day 8 provided allocations are made available to seller 1. In this case, the allocations must be moved from seller 2 to seller 1 in week 1 and week 2.

In another embodiment, report available-to-promise shortage (Report_Atp_Shortage) change allows demand fulfillment engines 212 to calculate the shortfall in the supply to satisfy the order completely on time. If, there is an option of expediting this supply from vendors or from the manufacturing, then the order could be promised on time. In the case of capable to promise (CTP) bill of materials (BOMs), the supply can be procured at more than one level (end item, first level components or the most upstream components etc.). This results into more than one option to solve the shortness or lateness. In addition, or as an alternative, demand fulfillment engines 212 provides the supply shortages only at the pre-decided products, as chosen during, for example, the deployment phase. In the case of a CTP environment, a large number of intermediates and finished goods can be manufactured from a small set of components.

In one embodiment, a user has control over supply of only some of the components and only of those intermediates which can also be procured from external vendors. So if the Reasons and Resolution report provides supply shortages at the intermediates or the components where extra supply cannot be mobilized, then the users is presented with too much of data that is not very useful. Products can be identified where supply may be flexible by marking them and these products are then called as Marked Buffers, discussed in more detail below.

This change reports the extra supply needed to promise an order completely and on time. This report may contain more than one option to improve the promise of the order. The user will have to select the option and increase the supply manually before repromising the order. This report contains multiple options in case the requested item can be manufactured from components. In case of a deep supply chain (multi-layers of BOM), the number of options could be very large.

In one embodiment, the products are marked to mobilize extra supply (these are referred to as marked buffers). In many cases extra supply can be arranged at intermediates and at the end items. In such cases, if the upstream components are marked, then only these components are chosen for providing the supply shortages.

To further illustrate the ATP shortage report, an example is now given. In the following example, an order for 40 units of item P is due on day 1. The supply of 10 units is available on day 1 and 10 units on day 5. The promise of the order is 10 units on day 1 and 10 units on day 5. When demand fulfillment engines 212 runs this strategy, it provides that the order can be promised on time (on day 1) if there is extra supply of item P on day 1. In this case, there is only one option and this will be reported only if the item P is marked.

For example, suppose item P can be manufactured from material M and capacity C. There is no supply of material M and there is supply of 50 units of capacity C on day 1. In this case, the strategy will provide two options for satisfying the order on time:
1. Supply of 30 units of item P on day 1.
2. Supply of 30 units of material M on day 1.

If there is no way to get extra supply of item P, i.e., this item is only manufactured and cannot be procured from outside, then the user will only mark material M. In that case the only option will be to increase the supply of material M.

Demand fulfillment engine 212 while computing the ATP shortage report first tries to use the existing supply of material and resources as much as possible (this is referred to as a balancing step). In order to explain the balancing step, an example is now given. In the following example, if an item P can be manufactured from M and C. All the products P, M and C are marked buffers and P has no supply. The supply at material M and capacity C is as shown below:

Material M: 10 units on day 2

Capacity C: 10 units on day 1

The order for 30 units is due on day 5. The ATP shortage report for this case will be as follows (there are two options):

Option 1:
Supply of 10 units of material M on day 1
Supply of 10 units of capacity C on day 2
Supply of 10 units of material M on day 5
Supply of 10 units of capacity C on day 5

Option 2:
Supply of 10 units of material M on day 1
Supply of 10 units of capacity C on day 2
Supply of 20 units of item P on day 5

The first two supply shortages are obtained because of consuming the existing supply, as much as possible. These supply shortages are computed before computing all other options and they are common to all the options.

As discussed above, products are referred to as Marked Buffers when these products are identified where supply may be flexible by marking them. In addition, these products may also be identified, where excess supply can be mobilized in case of constraints. In one embodiment, a user defined field (UDF) is created at the product root model to store if it is marked or not. The UDF at product root model is defined by creating the field in an Item Site Master table, stored in database 220. For example, if this field is field1. The marked buffers are set using the value in field field1 by using, for example, the following OIL script command in the planning script:

```
Supply_chains[1].sellers.for_each(#.product_roots.for_each(
        do(
              define(proot, #),
              if(proot.field1, proot.set_marked_buffers(proot.field1)),
      )
));
```

In another embodiment, it is possible to resolve late and short orders, in the case of BOMs, by moving allocation of one component and creating supply of other component. In addition, all such cases are reported in the Report_ATP_Shortage step if Report_Allocation_Shortage step has already been run earlier.

In addition, as discussed above, strategy model 222 includes one or more of the above discussed changes, wherein each of these changes are applied in the sequence in which they are defined. For example, if the strategy includes relax minimum quantity and relax quote multiple changes, then demand fulfillment engines 212 first calculates the impact of the minimum shipment quantity on the order and then relaxes the shipment lot size on top of it. In addition, the reasons and resolutions report will always provide the improvement in the promise by applying a first change, then applying a first and second change together and so on. This continues until demand fulfillment engines 212 runs all the changes in the strategy or the order is promised completely on time, whichever occurs first.

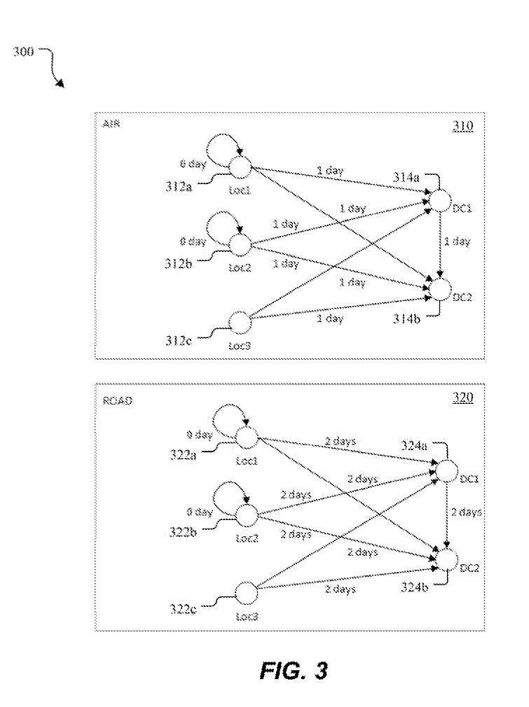

FIG. 3 illustrates an exemplary system 300 comprising two options for delivery services including air transportation mode 310 and road transportation mode 320 in accordance with an embodiment. System 300 comprises location 1 (Loc1) 312a, location 2 (Loc2) 312b, and location 3 (Loc3) 312c, distribution center 1 (DC 1) 314a, distribution center 2 (DC2) 314b and a plurality of delivery paths. Although a particular number of locations, distribution centers and delivery paths, are shown and described; embodiments contemplate any number of locations, distribution centers, and/or delivery paths, according to particular needs.

To further explain the operation of system 300 and an exemplary workflow of analyzing and resolving late and short order problems in system 300, an example is now given. In the following example, Item1 is available at Loc1 312a, Loc2 312b, and Loc3 312c. The supply of Item1 is shown below in Table 1.

TABLE 1

| Seller | Item | Location | Start Date | End Date | Allocated | Consumed | Available |
|---|---|---|---|---|---|---|---|
| T | Item1 | Loc1 | 10/6/2007 | 10/7/2007 | 15 | 0 | 15 |
| T | Item1 | Loc2 | 10/5/2007 | 10/6/2007 | 15 | 0 | 15 |
| T | Item1 | Loc3 | 10/5/2007 | 10/6/2007 | 15 | 0 | 15 |

Allocations of Item1 to sellers 51 and S2 are shown below in Table 2.

TABLE 2

| | | | | | Allo- | Con- | |
|---|---|---|---|---|---|---|---|
| Seller | Item | Location | Start Date | End Date | cated | sumed | ATP |
| S1 | Item1 | Loc1 | 10/1/2007 | 10/8/2007 | 10 | 0 | 10 |
| S2 | Item1 | Loc1 | 10/1/2007 | 10/8/2007 | 5 | 0 | 5 |
| S1 | Item1 | Loc2 | 10/1/2007 | 10/8/2007 | 10 | 0 | 10 |
| S2 | Item1 | Loc2 | 10/1/2007 | 10/8/2007 | 5 | 0 | 5 |
| S1 | Item1 | Loc3 | 10/1/2007 | 10/8/2007 | 10 | 0 | 10 |
| S2 | Item1 | Loc3 | 10/1/2007 | 10/8/2007 | 5 | 0 | 5 |

In this example, the order is Order01-Item1 for 60 units of Item1 at seller S1 due on Oct. 6, 2007 with the destination of a distribution center 2 (DC2) 314b. In this example, the promising policy is ASAP and the following attributes are set on item request:

permitted delivery zones: DC1 314a

permitted delivery sources: Loc2 312b and Loc3 312c

permitted delivery services: Road transportation mode 320

permitted matching product roots: Item1::SKU::Loc3

Since the permitted delivery zone is DC1 314a and the destination is DC2 314b, the last edge of the delivery is DC1 314a→DC2 314b. As shown above, the permitted delivery sources and permitted matching product roots restrict the consumption from only Loc3 312c, therefore, only one delivery path is possible: Loc3 312c→DC1 314a→DC2 314b.

Continuing with this example, the maximum edges on delivery request has a default value of 1 and the delivery cannot be made with a delivery path with 2 edges. Therefore, Order01-Item1 is completely shorted.

The strategy changes (described above) in this example have the following steps in the same sequence:

1. RELAX_MAX_EDGES

2. RELAX_PERMITTED_DELIVERY_ZONES

3. RELAX_PERMITTED_MATCHING_PRODUCTS

4. RELAX_PERMITTED_DELIVERY_SOURCES

5. RELAX_PERMITTED_DELIVERY_SERVICES

6. REPORT_ALLOCATION_SHORTAGE

7. REPORT_ATP_SHORTAGE

In this example, the first step, relax maximum edges, will run for the late and short item after re-promising. However, since there is no change in the supply picture, re-promise will provide the same results i.e. no promise. Therefore, the first step is to run relax maximum edges for the quantity of 60 units, provided in the order of this example of Order01-Item1.

Results: On_time_qty 0 late_qty 10 late_date 07-10-08 short_qty 50

The API output is as follows:

```
<dfx:StrategyStepResult>
      <dfx:StrategyStepName>
          <dfx:Value>RELAX_MAX_EDGES</dfx:Value>
      </dfx:StrategyStepName>
      <dfx:PromiseInformation>
          <dfx:PromiseQuantityOnTime Value=“0”>
          </dfx:PromiseQuantityOnTime>
          <dfx:PromiseQuantityLate Value=“10”>
          </dfx:PromiseQuantityLate>
          <dfx:PromiseQuantityShort Value=“50”>
          </dfx:PromiseQuantityShort>
          <dfx:LateDate Value=“10/08/2007”></dfx:LateDate>
      </dfx:PromiseInformation>
</dfx:StrategyStepResult>
```

As shown above, after relaxing maximum edges constraint, Loc3 312c→DC 1 314a→DC2 314b becomes a possible delivery path and therefore a promise of a quantity of 10 units can be offered on day 8 after consuming the allocation of Item1::SKU::Loc3 at S1. In addition, due to permitted delivery service constraint, the last edge of the delivery DC 1 314a→DC2 314b has to use road transportation mode 320 which as shown in FIG. 3, is 2 days. However, Loc3 312c→DC1 314A can use air transportation mode 310, shown in FIG. 3 which is a less time consuming service and only takes 1 day. Therefore the total delivery time is 3 days. Supply at Loc3 312c is available on day 5 and therefore a promise is offered after 3 days i.e. on day 8.

Continuing with this example, the next step is to run relax permitted devlivery zones for late and short item from the previous step which is again 60 units (i.e., 10 late and 50 short).

Results: On_time_qty 0 late_qty 10 late_date 07-10-07 short_qty 50

The API output is as follows:

```
<dfx:StrategyStepResult>
      <dfx:StrategyStepName>
          <dfx:Value>RELAX_PERMITTED_DELIVERY_ZONES</dfx:Value>
      </dfx:StrategyStepName>
      <dfx:PromiseInformation>
          <dfx:PromiseQuantityOnTime Value=“0”></dfx:PromiseQuantityOnTime>
          <dfx:PromiseQuantityLate Value=“10”></dfx:PromiseQuantityLate>
          <dfx:PromiseQuantityShort Value=“50”></dfx:PromiseQuantityShort>
          <dfx:LateDate Value=“10/07/2007”></dfx:LateDate>
      </dfx:PromiseInformation>
</dfx:StrategyStepResult>
```

As shown above, after relaxing permitted delivery zones constraint, 2 delivery paths are possible—one which is shown in the previous step and the second is Loc3 312c→DC2 314b using road transportation mode 320 which as shown in FIG. 3, is 2 days. The latter is given preference, in this example, because it takes less delivery time, i.e., 2 days. Therefore, the promise offered in the previous step, can now be offered 1 day earlier i.e. on day 7.

Continuing with this example, the next step is to run relax permitted matching products for late and short item from previous step which is again 60 units.

Results: On_time_qty 0 late_qty 20 late_date 07-10-07 short_qty 40

The API output is as follows:

```
<dfx:StrategyStepResult>
      <dfx:StrategyStepName>
      <dfx:Value>RELAX_PERMITTED_MATCHING_PRODUCTS</dfx:Value>
      </dfx:StrategyStepName>
      <dfx:PromiseInformation>
          <dfx:PromiseQuantityOnTime Value=“0”></dfx:PromiseQuantityOnTime>
          <dfx:PromiseQuantityLate Value=“20”></dfx:PromiseQuantityLate>
          <dfx:PromiseQuantityShort Value=“40”></dfx:PromiseQuantityShort>
          <dfx:LateDate Value=“10/07/2007”></dfx:LateDate>
      </dfx:PromiseInformation>
</dfx:StrategyStepResult>
```

As shown above, after relaxing permitted matching product roots constraint, supply of 10 units at Loc2 312b can also be consumed (supply at Loc1 312a still cannot be consumed due to permitted delivery sources constraint). Loc2 312b and Loc3 312c have a similar delivery network and therefore a similar delivery path is taken (Loc2 312b→DC2 314b). The promise offered in the previous step is improved by a quantity of 10 units and a total promise of 20 units can now be offered on day 7.

Continuing with this example, the next step is to run relax permitted delivery sources for late and short item from the previous step which is again 60 units.

Results: On_time_qty 0 late_qty 30 late_date 07-10-08 short_qty 30

The API output is as follows:

```
<dfx:StrategyStepResult>
      <dfx:StrategyStepName>
          <dfx:Value>RELAX_PERMITTED_DELIVERY_SOURCES</dfx:Value>
      </dfx:StrategyStepName>
      <dfx:PromiseInformation>
          <dfx:PromiseQuantityOnTime Value=“0”></dfx:PromiseQuantityOnTime>
          <dfx:PromiseQuantityLate Value=“30”></dfx:PromiseQuantityLate>
          <dfx:PromiseQuantityShort Value=“30”></dfx:PromiseQuantityShort>
          <dfx:LateDate Value=“10/08/2007”></dfx:LateDate>
      </dfx:PromiseInformation>
</dfx:StrategyStepResult>
```

As shown above, after relaxing permitted delivery sources constraint, supply of 10 units at Loc1 312a can also be consumed. Loc1 312a, Loc2 312b, and Loc3 312c have similar delivery networks and therefore a similar delivery path is taken (Loc1 312a→DC2 314B). Since supply at Loc1 312a is available on day 6, the promise from Loc1 312a can be offered on day 8 (2 days delivery time).

For reporting purpose, all the late promise quantities are aggregated and shown on last promise date. Therefore, a promise of 30 units can now be offered on day 8.

Continuing with this example, the next step is to run relax permitted delivery services for late and short item from the previous step which is again 60 units.

Results: On_time_qty 20 late_qty 10 late_date 07-10-07 short_qty 30

The API output is as follows:

```
<dfx:StrategyStepResult>
      <dfx:StrategyStepName>
          <dfx:Value>RELAX_PERMITTED_DELIVERY_SERVICES<dfx:Value>
      </dfx:StrategyStepName>
      <dfx:PromiseInformation>
          <dfx:PromiseQuantityOnTime Value=“20”></dfx:PromiseQuantityOnTime>
          <dfx:PromiseQuantityLate Value=“10”></dfx:PromiseQuantityLate>
          <dfx:PromiseQuantityShort Value=“30”></dfx:PromiseQuantityShort>
          <dfx:LateDate Value=“10/07/2007”></dfx:LateDate>
      </dfx:PromiseInformation>
</dfx:StrategyStepResult>
```

As shown above, after relaxing permitted delivery services constraint, air transportation mode 310, shown in FIG. 3 which is a less time consuming service and will be reduced to 1 day. Loc2 312b and Loc3 312c can now provide an on-time promise on day 6 (supply on day 5) whereas Loc 1 312a will still provide a late promise on day 7 (supply on day 6).

Continuing with this example, the next step is to run report allocation shortage for late and short item from the previous step which is now 40 units.

Results: On_time_qty 10 late_qty 15 late_date 07-10-07 short_qty 15

Allocation Required for Product Item1::SKU::Loc2-S1::Level2 on FE Start Date 07-10-01 for Qty 5 Is_On_Time TRUE

Allocation Required for Product Item1::SKU::Loc3-S1::Level2 on FE Start Date 07-10-01 for Qty 5 Is_On_Time TRUE

Allocation Required for Product Item1::SKU::Loc1-S1::Level2 on FE Start Date 07-10-01 for Qty 5 Is_On_Time FALSE

The API output is as follows:

```
<dfx:StrategyStepResult>
  <dfx:AllocationReport>
    <dfx:AllocationNeeded>
      <dfx:Product>
        <dfx:Item Value=“Item1”></dfx:Item>
        <dfx:ProductLevel Value=“SKU”></dfx:ProductLevel>
        <dfx:ProductLocation Value=“Loc2”></dfx:ProductLocation>
      </dfx:Product>
      <dfx:Seller>
        <dfx:SellerName Value=“S1”></dfx:SellerName>
        <dfx:SellerLevel Value=“Level2”></dfx:SellerLevel>
      </dfx:Seller>
      <dfx:ForecastBucket>
        <dfx:StartDate Value=“10/01/2007”></dfx:StartDate>
        <dfx:EndDate Value=“10/08/2007”></dfx:EndDate>
      </dfx:ForecastBucket>
      <dfx:ShortageQty Value=“5”></dfx:ShortageQty>
      <dfx:OnTime Value=“TRUE”></dfx:OnTime>
    </dfx:AllocationNeeded>
    <dfx:AllocationNeeded>
      <dfx:Product>
        <dfx:Item Value=“Item1”></dfx:Item>
        <dfx:ProductLevel Value=“SKU”></dfx:ProductLevel>
        <dfx:ProductLocation Value=“Loc3”></dfx:ProductLocation>
      </dfx:Product>
      <dfx:Seller>
        <dfx:SellerName Value=“S1”></dfx:SellerName>
        <dfx:SellerLevel Value=“Level2”></dfx:SellerLevel>
      </dfx:Seller>
      <dfx:ForecastBucket>
        <dfx:StartDate Value=“10/01/2007”></dfx:StartDate>
        <dfx:EndDate Value=“10/08/2007”></dfx:EndDate>
      </dfx:ForecastBucket>
      <dfx:ShortageQty Value=“5”></dfx:ShortageQty>
      <dfx:OnTime Value=“TRUE”></dfx:OnTime>
    </dfx:AllocationNeeded>
    <dfx:AllocationNeeded>
      <dfx:Product>
        <dfx:Item Value=“Item1”></dfx:Item>
        <dfx:ProductLevel Value=“SKU”></dfx:ProductLevel>
        <dfx:ProductLocation Value=“Loc1”></dfx:ProductLocation>
      </dfx:Product>
      <dfx:Seller>
        <dfx:SellerName Value=“S1”></dfx:SellerName>
        <dfx:SellerLevel Value=“Level2”></dfx:SellerLevel>
      </dfx:Seller>
      <dfx:ForecastBucket>
        <dfx:StartDate Value=“10/01/2007”></dfx:StartDate>
        <dfx:EndDate Value=“10/08/2007”></dfx:EndDate>
      </dfx:ForecastBucket>
      <dfx:ShortageQty Value=“5”></dfx:ShortageQty>
      <dfx:OnTime Value=“FALSE”></dfx:OnTime>
    </dfx:AllocationNeeded>
  </dfx:AllocationReport>
  <dfx:StrategyStepName>
    <dfx:Value>REPORT_ALLOCATION_SHORTAGE</dfx:Value>
  </dfx:StrategyStepName>
  <dfx:PromiseInformation>
    <dfx:PromiseQuantityOnTime Value=“10”>
    </dfx:PromiseQuantityOnTime>
    <dfx:PromiseQuantityLate Value=“15”></dfx:PromiseQuantityLate>
    <dfx:PromiseQuantityShort Value=“15”>
    </dfx:PromiseQuantityShort>
    <dfx:LateDate Value=“10/07/2007”></dfx:LateDate>
  </dfx:PromiseInformation>
</dfx:StrategyStepResult>
```

As shown above, the report allocation shortage step provides that any remaining supply which could not be consumed yet but can be used after some move allocation steps. In addition, the report allocation shortage step also provides that if a particular move allocation step will add to on-time promise or late promise. Note that it only provides ‘to_seller’ information of a move allocation step and doesn't provide ‘from_seller’ information, e.g., here it provides that for Item1::SKU::Loc2, the quantity of 5 units is still available ‘at some seller’ but needs to be allocated to S1::Level2 to improve the on-time promise; same for Item1::SKU::Loc3. Similarly for Item1::SKU::Loc3, the quantity of 5 units is still available ‘at some seller’ but needs to be allocated to S1::Level2 to improve the late promise

Continuing with this example, the next step is to run report ATP shortage for late and short item from the previous step which is now 30 units.

Results: On_time_qty 30 late_qty 0 late_date -------- short_qty 0

ATP Option Number-1
Atp Qty Needed 30 For Product Item1::SKU::Loc3 on ATP Bucket Start Date 07-10-05 Is_On_Time TRUE

The API output is as follows:

```
<dfx:StrategyStepResult>
  <dfx:ATPReport>
    <dfx:ATPShortageOption>
      <dfx:ATPShortageRequirement>
        <dfx:Product>
          <dfx:Item Value=“Item1”></dfx:Item>
          <dfx:ProductLevel
Value=“SKU”></dfx:ProductLevel>
          <dfx:ProductLocation
Value=“Loc3”></dfx:ProductLocation>
        </dfx:Product>
        <dfx:Seller>
          <dfx:SellerName Value=“S1”></dfx:SellerName>
          <dfx:SellerLevel Value=“Level2”></dfx:SellerLevel>
        </dfx:Seller>
        <dfx:ATPBucket>
          <dfx:StartDate Value=“10/05/2007”></dfx:StartDate>
          <dfx:EndDate Value=“10/06/2007”></dfx:EndDate>
        </dfx:ATPBucket>
        <dfx:ShortageQty Value=“30”></dfx:ShortageQty>
        <dfx:OnTime Value=“TRUE”></dfx:OnTime>
      </dfx:ATPShortageRequirement>
    </dfx:ATPShortageOption>
  </dfx:ATPReport>
  <dfx:StrategyStepName>
    <dfx:Value>REPORT_ATP_SHORTAGE</dfx:Value>
  </dfx:StrategyStepName>
  <dfx:PromiseInformation>
    <dfx:PromiseQuantityOnTime Value=“30”>
    </dfx:PromiseQuantityOnTime>
    <dfx:PromiseQuantityLate Value=“0”></dfx:PromiseQuantityLate>
    <dfx:PromiseQuantityShort Value=“0”></dfx:PromiseQuantityShort>
    <dfx:LateDate Value=“----------”></dfx:LateDate>
  </dfx:PromiseInformation>
</dfx:StrategyStepResult>
```

As shown above, the report available to promise shortage step considers the ‘marked_buffer’ concept to reduce the number of options in CTP scenarios. Any product for which marked_buffer is set to ‘true’ is only considered to be available to procure more supply.

In this case all 3 products—Item1::SKU::Loc1, Item1::SKU::Loc2 and Item1::SKU::Loc3, have marked_buffer set to ‘true’. Therefore, there could be possibly 3 available to promise (ATP) options for improving the on-time promise by 30—procure a quantity of 30 units of either of Item1::SKU::Loc1 or Item1::SKU::Loc2 or Item1::SKU::Loc3 on day 5.

For a forecast in item_request.matching_forecasts list, ______ first looks for that forecast and its BOM and determines all of the possible ATP options. In addition, even if there is some lateness and/or shortness then ______ only goes to next forecast to evaluate further. However, when the promise is already fulfilled on-time with that forecast, ______ will not go to the next forecast.

In this example, the first forecast in item_request.matching_forecasts list which happens to be Item1::SKU::Loc3, itself is able to fulfill the promise on-time, therefore, in this example, other forecasts in the list are not evaluated and only one option is shown.

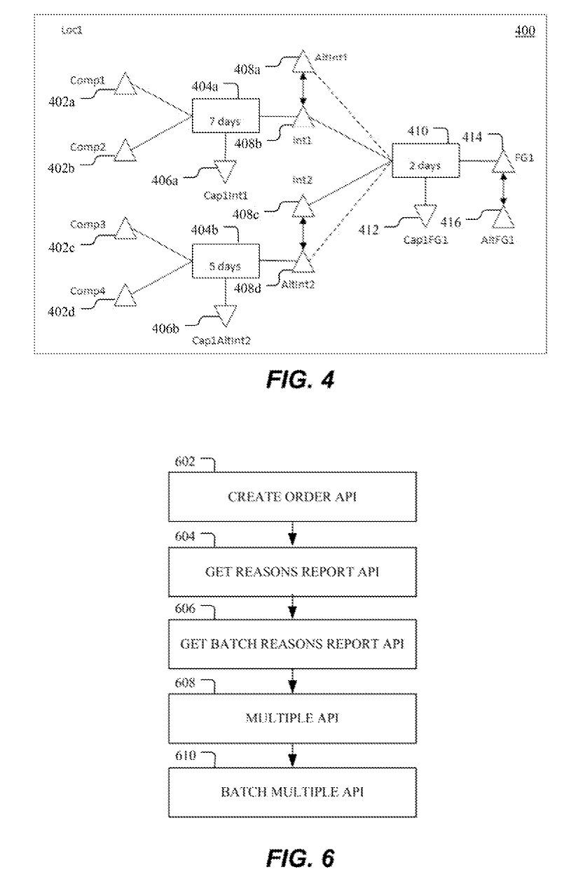

FIG. 4 illustrates an exemplary location 400 in accordance with an one embodiment. Location 400 comprises component 1 (Comp1) 402a, component 2 (Comp2) 402b, component 3 (Comp3) 402c, component 4 (Comp4) 402d, buffers 404a, 404b, and 410, intermediate capacity 1 (CapIint1) 406a, intermediate capacity 2 (CapIint2) 406b, alternate intermediate component 1 (AltInt1) 408a, intermediate component 1 (Int1) 408b, intermediate component 2 (Int2) 408c, alternate intermediate component 2 (AltInt2) 408d, finished good capacity 1 (CapFG1) 412, finished good 1 (FG1) 414, and alternate finished good 1 (AltFG1) 416. Although a particular number of components, buffers, intermediate capacity, alternate intermediate components, intermediate components, finished good capacity, finished goods, and/or alternate finished goods, are shown and described; embodiments contemplate any number of components, buffers, intermediate capacity, alternate intermediate components, intermediate components, finished good capacity, finished goods, and/or alternate finished goods according to particular needs.

To further explain the operation of location 400 and an exemplary workflow of analyzing and resolving late and short order problems in location 400, an example is now given. In the following example, a supply of a finished good (FG1) item is shown below in Table 3.

TABLE 3

| Seller | Item | Location | Start Date | End Date | Allocated | Consumed | Available |
|---|---|---|---|---|---|---|---|
| T | FG1 | Loc1 | 10/10/2007 | 10/11/2007 | 50 | 0 | 50 |
| T | FG1 | Loc1 | 10/15/2007 | 10/16/2007 | 10 | 0 | 10 |

In addition, the allocations of FG1 to sellers S1 and S2 are shown below in Table 4.

TABLE 4

| Seller | Item | Location | Start Date | End Date | Allocated | Consumed | ATP |
|---|---|---|---|---|---|---|---|
| S1 | FG1 | Loc1 | 10/8/2007 | 10/15/2007 | 40 | 0 | 40 |
| S2 | FG1 | Loc1 | 10/8/2007 | 10/15/2007 | 10 | 0 | 10 |
| S1 | FG1 | Loc1 | 10/15/2007 | 10/22/2007 | 10 | 0 | 10 |

In this example, the order is Order01-FG1-Loc1 for 170 units of FG 1 at seller S1 due on Oct. 8, 2007 and the promising policy is ASAP. However, in this example, there is not any on-time promises, only two late promises—40 units on day 10 and 10 units on day 15 will be offered and the remaining 120 units will be shorted.

The strategy changes (described above) in this example have the following steps in the same sequence:

1. REPORT_ALLOCATION SHORTAGE

2. REPORT_ATP_SHORTAGE

In this example, the first step, report allocation shortage, is run for the late and short item after re-promising. However, since there is no change is the supply picture, re-promise will provide same results i.e., no on-time promise. Therefore, the first step is to run the report allocation shortage for the quantity of 170 units, provided in the order of this example of Order01-FG1-Loc1.

Results: On_time_qty 0 late_qty 60 late_date 07-10-15 short_qty 110

Allocation Required for Product FG1::SKU::Loc1-S1::Level2 on FE Start Date 07-10-08 for Qty 10 Is_On_Time FALSE

The API output is as follows:

<dfx:StrategyStepResult>
<dfx:AllocationReport>
<dfx:AllocationNeeded>
<dfx:Product>
<dfx:Item Value=“FG1”></dfx:Item>
<dfx:ProductLevel Value=“SKU”></dfx:ProductLevel>
<dfx:ProductLocation Value=“Loc1”></dfx:ProductLocation>
</dfx:Product>
<dfx:Seller>
<dfx:SellerName Value=“S1”></dfx:SellerName>
<dfx:SellerLevel Value=“Level2”></dfx:SellerLevel>
</dfx:Seller>
<dfx:ForecastBucket>
<dfx:StartDate Value=“10/08/2007”></dfx:StartDate>
<dfx:EndDate Value=“10/15/2007”></dfx:EndDate>
</dfx:ForecastBucket>
<dfx:ShortageQty Value=“10”></dfx:ShortageQty>
<dfx:OnTime Value=“FALSE”></dfx:OnTime>
</dfx:AllocationNeeded>
</dfx:AllocationReport>
<dfx:StrategyStepName>
<dfx:Value>REPORT_ALLOCATION_SHORTAGE</dfx:Value>
</dfx:StrategyStepName>
<dfx:PromiseInformation>
<dfx:PromiseQuantityOnTime Value=“0”>
</dfx:PromiseQuantityOnTime>
<dfx:PromiseQuantityLate Value=“60”></dfx:PromiseQuantityLate>
<dfx:PromiseQuantityShort Value=“110”></dfx:PromiseQuantityShort>
<dfx:LateDate Value=“10/15/2007”></dfx:LateDate>
</dfx:PromiseInformation>
</dfx:StrategyStepResult>

As shown above, the report allocation shortage step provides any remaining supply which could not be consumed yet but can be used after some move allocation steps. It also provides if a particular move allocation step will add to on-time promise or late promise. Note that it only provides ‘to_seller’ information of a move allocation step and doesn't provide ‘from_seller’ information, e.g. here it provides that for FG1::SKU::Loc1, quantity of 10 units are still available ‘at some seller’ but needs to be allocated to S1::Level2 to improve the late promise. So overall, two late promises—50 units on day 10 and 10 units on day 15 can be offered after the suggested move allocation step.

In addition, for reporting purposes, all of the late promise quantities are aggregated and shown on last promise date. Therefore, a promise of 60 units on day 15 is provided.

Continuing with this example, the next step, report ATP shortage, is to run for late and short items from the previous step which is again 170 units.

Results: On_time_qty 170 late_qty 0 late_date -------- short_qty 0 ATP Option Number-1

Atp Qty Needed 170 For Product FG1::SKU::Loc1 on ATP Bucket Start Date 07-10-08 Is_On_Time TRUE ATP Option Number-2

Atp Qty Needed 170 For Product AltFG1::SKU::Loc1 on ATP Bucket Start Date 07-10-08 Is_On_Time TRUE ATP Option Number-3

Atp Qty Needed 180 For Product Int2::SKU::Loc1 on ATP Bucket Start Date 07-10-06 Is_On_Time TRUE

Atp Qty Needed 180 For Product Int1::SKU::Loc1 on ATP Bucket Start Date 07-10-06 Is_On_Time TRUE

Atp Qty Needed 180 For Product Cap1FG1:W1::RES::Loc1 on ATP Bucket Start Date 07-10-06 Is_On_Time TRUE

ATP Option Number-4

Atp Qty Needed 180 For Product AltInt2::SKU::Loc1 on ATP Bucket Start Date 07-10-06 Is_On_Time TRUE

Atp Qty Needed 180 For Product Int1::SKU::Loc1 on ATP Bucket Start Date 07-10-06 Is_On_Time TRUE

Atp Qty Needed 180 For Product Cap1FG1:W1::RES::Loc1 on ATP Bucket Start Date 07-10-06 Is_On_Time TRUE ATP Option Number-5

Atp Qty Needed 201 For Product Comp4::SKU::Loc1 on ATP Bucket Start Date 07-10-01 Is_On_Time TRUE

Atp Qty Needed 201 For Product Comp3::SKU::Loc1 on ATP Bucket Start Date 07-10-01 Is_On_Time TRUE

Atp Qty Needed 201 For Product Cap1AltInt2:W1::RES::Loc1 on ATP Bucket Start Date 07-10-01 Is_On_Time TRUE

Atp Qty Needed 180 For Product Int1::SKU::Loc1 on ATP Bucket Start Date 07-10-06 Is_On_Time TRUE

Atp Qty Needed 180 For Product Cap1FG1:W1::RES::Loc1 on ATP Bucket Start Date 07-10-06 Is_On_Time TRUE

ATP Option Number-6

Atp Qty Needed 180 For Product Int2::SKU::Loc1 on ATP Bucket Start Date 07-10-06 Is_On_Time TRUE

Atp Qty Needed 180 For Product AltInt1::SKU::Loc1 on ATP Bucket Start Date 07-10-06 Is_On_Time TRUE

Atp Qty Needed 180 For Product Cap1FG1:W1::RES::Loc1 on ATP Bucket Start Date 07-10-06 Is_On_Time TRUE ATP Option Number-7

Atp Qty Needed 180 For Product AltInt2::SKU::Loc1 on ATP Bucket Start Date 07-10-06 Is_On_Time TRUE

Atp Qty Needed 180 For Product AltInt1::SKU::Loc1 on ATP Bucket Start Date 07-10-06 Is_On_Time TRUE

Atp Qty Needed 180 For Product Cap1FG1:W1::RES::Loc1 on ATP Bucket Start Date 07-10-06 Is_On_Time TRUE ATP Option Number-8

Atp Qty Needed 201 For Product Comp4::SKU::Loc1 on ATP Bucket Start Date 07-10-01 Is_On_Time TRUE

Atp Qty Needed 201 For Product Comp3::SKU::Loc1 on ATP Bucket Start Date 07-10-01 Is_On_Time TRUE

Atp Qty Needed 201 For Product Cap1AltInt2:W1::RES::Loc1 on ATP Bucket Start Date 07-10-01 Is_On_Time TRUE

Atp Qty Needed 180 For Product AltInt1::SKU::Loc1 on ATP Bucket Start Date 07-10-06 Is_On_Time TRUE

Atp Qty Needed 180 For Product Cap1FG1:W1::RES::Loc1 on ATP Bucket Start Date 07-10-06 Is_On_Time TRUE

The API output is as follows:

```
<dfx:StrategyStepResult>
    <dfx:ATPReport>
    <dfx:ATPShortageOption>
        <dfx:ATPShortageRequirement>
        <dfx:Product>
        <dfx:Item Value=“FG1”></dfx:Item>
        <dfx:ProductLevel Value=“SKU”></dfx:ProductLevel>
        <dfx:ProductLocation Value=“Loc1”></dfx:ProductLocation>
        </dfx:Product>
        <dfx:Seller>
        <dfx:SellerName Value=“S1”></dfx:SellerName>
        <dfx:SellerLevel Value=“Level2”></dfx:SellerLevel>
        </dfx:Seller>
        <dfx:ATPBucket>
        <dfx:StartDate Value=“10/08/2007”></dfx:StartDate>
        <dfx:EndDate Value=“10/09/2007”></dfx:EndDate>
        </dfx:ATPBucket>
        <dfx:ShortageQty Value=“170”></dfx:ShortageQty>
        <dfx:OnTime Value=“TRUE”></dfx:OnTime>
        </dfx:ATPShortageRequirement>
    </dfx:ATPShortageOption>
    <dfx:ATPShortageOption>
        <dfx:ATPShortageRequirement>
        <dfx:Product>
        <dfx:Item Value=“AltFG1”></dfx:Item>
        <dfx:ProductLevel Value=“SKU”></dfx:ProductLevel>
        <dfx:ProductLocation Value=“Loc1”></dfx:ProductLocation>
        </dfx:Product>
        <dfx:Seller>
        <dfx:SellerName Value=“S1”></dfx:SellerName>
        <dfx:SellerLevel Value=“Level2”></dfx:SellerLevel>
        </dfx:Seller>
        <dfx:ATPBucket>
        <dfx:StartDate Value=“10/08/2007”></dfx:StartDate>
        <dfx:EndDate Value=“10/09/2007”></dfx:EndDate>
        </dfx:ATPBucket>
        <dfx:ShortageQty Value=“170”></dfx:ShortageQty>
        <dfx:OnTime Value=“TRUE”></dfx:OnTime>
        </dfx:ATPShortageRequirement>
    </dfx:ATPShortageOption>
    <dfx:ATPShortageOption>
        <dfx:ATPShortageRequirement>
        <dfx:Product>
        <dfx:Item Value=“Int2”></dfx:Item>
        <dfx:ProductLevel Value=“SKU”></dfx:ProductLevel>
        <dfx:ProductLocation Value=“Loc1”></dfx:ProductLocation>
        </dfx:Product>
        <dfx:Seller>
        <dfx:SellerName Value=“S1”></dfx:SellerName>
        <dfx:SellerLevel Value=“Level2”></dfx:SellerLevel>
        </dfx:Seller>
        <dfx:ATPBucket>
        <dfx:StartDate Value=“10/06/2007”></dfx:StartDate>
        <dfx:EndDate Value=“10/07/2007”></dfx:EndDate>
        </dfx:ATPBucket>
        <dfx:ShortageQty Value=“180”></dfx:ShortageQty>
        <dfx:OnTime Value=“TRUE”></dfx:OnTime>
        </dfx:ATPShortageRequirement>
        <dfx:ATPShortageRequirement>
        <dfx:Product>
        <dfx:Item Value=“Int1”></dfx:Item>
        <dfx:ProductLevel Value=“SKU”></dfx:ProductLevel>
        <dfx:ProductLocation Value=“Loc1”></dfx:ProductLocation>
        </dfx:Product>
        <dfx:Seller>
        <dfx:SellerName Value=“S1”></dfx:SellerName>
        <dfx:SellerLevel Value=“Level2”></dfx:SellerLevel>
        </dfx:Seller>
        <dfx:ATPBucket>
        <dfx:StartDate Value=“10/06/2007”></dfx:StartDate>
        <dfx:EndDate Value=“10/07/2007”></dfx:EndDate>
        </dfx:ATPBucket>
        <dfx:ShortageQty Value=“180”></dfx:ShortageQty>
        <dfx:OnTime Value=“TRUE”></dfx:OnTime>
        </dfx:ATPShortageRequirement>
        <dfx:ATPShortageRequirement>
        <dfx:Product>
        <dfx:Item Value=“Cap1FG1”></dfx:Item>
        <dfx:ProductLevel Value=“RES”></dfx:ProductLevel>
        <dfx:ProductLocation Value=“Loc1”></dfx:ProductLocation>
        <dfx:WorkcenterName Value=“W1”></dfx:WorkcenterName>
        </dfx:Product>
        <dfx:Seller>
        <dfx:SellerName Value=“S1”></dfx:SellerName>
        <dfx:SellerLevel Value=“Level2”></dfx:SellerLevel>
        </dfx:Seller>
        <dfx:ATPBucket>
        <dfx:StartDate Value=“10/06/2007”></dfx:StartDate>
        <dfx:EndDate Value=“10/07/2007”></dfx:EndDate>
        </dfx:ATPBucket>
        <dfx:ShortageQty Value=“180”></dfx:ShortageQty>
        <dfx:OnTime Value=“TRUE”></dfx:OnTime>
        </dfx:ATPShortageRequirement>
    </dfx:ATPShortageOption>
    <dfx:ATPShortageOption>
        <dfx:ATPShortageRequirement>
        <dfx:Product>
        <dfx:Item Value=“AltInt2”></dfx:Item>
        <dfx:ProductLevel Value=“SKU”></dfx:ProductLevel>
        <dfx:ProductLocation Value=“Loc1”></dfx:ProductLocation>
        </dfx:Product>
        <dfx:Seller>
        <dfx:SellerName Value=“S1”></dfx:SellerName>
        <dfx:SellerLevel Value=“Level2”></dfx:SellerLevel>
        </dfx:Seller>
        <dfx:ATPBucket>
        <dfx:StartDate Value=“10/06/2007”></dfx:StartDate>
        <dfx:EndDate Value=“10/07/2007”></dfx:EndDate>
        </dfx:ATPBucket>
        <dfx:ShortageQty Value=“180”></dfx:ShortageQty>
        <dfx:OnTime Value=“TRUE”></dfx:OnTime>
        </dfx:ATPShortageRequirement>
        <dfx:ATPShortageRequirement>
        <dfx:Product>
        <dfx:Item Value=“Int1”></dfx:Item>
        <dfx:ProductLevel Value=“SKU”></dfx:ProductLevel>
        <dfx:ProductLocation Value=“Loc1”></dfx:ProductLocation>
        </dfx:Product>
        <dfx:Seller>
        <dfx:SellerName Value=“S1”></dfx:SellerName>
            <dfx:SellerLevel Value=“Level2”></dfx:SellerLevel>
        </dfx:Seller>
        <dfx:ATPBucket>
        <dfx:StartDate Value=“10/06/2007”></dfx:StartDate>
        <dfx:EndDate Value=“10/07/2007”></dfx:EndDate>
        </dfx:ATPBucket>
        <dfx:ShortageQty Value=“180”></dfx:ShortageQty>
        <dfx:OnTime Value=“TRUE”></dfx:OnTime>
        </dfx:ATPShortageRequirement>
        <dfx:ATPShortageRequirement>
        <dfx:Product>
        <dfx:Item Value=“Cap1FG1”></dfx:Item>
        <dfx:ProductLevel Value=“RES”></dfx:ProductLevel>
        <dfx:ProductLocation Value=“Loc1”></dfx:ProductLocation>
        <dfx:WorkcenterName Value=“W1”></dfx:WorkcenterName>
        </dfx:Product>
        <dfx:Seller>
        <dfx:SellerName Value=“S1”></dfx:SellerName>
        <dfx:SellerLevel Value=“Level2”></dfx:SellerLevel>
        </dfx:Seller>
        <dfx:ATPBucket>
        <dfx:StartDate Value=“10/06/2007”></dfx:StartDate>
        <dfx:EndDate Value=“10/07/2007”></dfx:EndDate>
        </dfx:ATPBucket>
        <dfx:ShortageQty Value=“180”></dfx:ShortageQty>
        <dfx:OnTime Value=“TRUE”></dfx:OnTime>
        </dfx:ATPShortageRequirement>
    </dfx:ATPShortageOption>
    <dfx:ATPShortageOption>
        <dfx:ATPShortageRequirement>
        <dfx:Product>
        <dfx:Item Value=“Comp4”></dfx:Item>
        <dfx:ProductLevel Value=“SKU”></dfx:ProductLevel>
        <dfx:ProductLocation Value=“Loc1”></dfx:ProductLocation>
        </dfx:Product>
        <dfx:Seller>
        <dfx:SellerName Value=“S1”></dfx:SellerName>
        <dfx:SellerLevel Value=“Level2”></dfx:SellerLevel>
        </dfx:Seller>
        <dfx:ATPBucket>
        <dfx:StartDate Value=“10/01/2007”></dfx:StartDate>
        <dfx:EndDate Value=“10/02/2007”></dfx:EndDate>
        </dfx:ATPBucket>
        <dfx:ShortageQty Value=“201”></dfx:ShortageQty>
        <dfx:OnTime Value=“TRUE”></dfx:OnTime>
        </dfx:ATPShortageRequirement>
        <dfx:ATPShortageRequirement>
        <dfx:Product>
        <dfx:Item Value=“Comp3”></dfx:Item>
        <dfx:ProductLevel Value=“SKU”></dfx:ProductLevel>
        <dfx:ProductLocation Value=“Loc1”></dfx:ProductLocation>
        </dfx:Product>
        <dfx:Seller>
        <dfx:SellerName Value=“S1”></dfx:SellerName>
        <dfx:SellerLevel Value=“Level2”></dfx:SellerLevel>
        </dfx:Seller>
        <dfx:ATPBucket>
        <dfx:StartDate Value=“10/01/2007”></dfx:StartDate>
        <dfx:EndDate Value=“10/02/2007”></dfx:EndDate>
        </dfx:ATPBucket>
        <dfx:ShortageQty Value=“201”></dfx:ShortageQty>
        <dfx:OnTime Value=“TRUE”></dfx:OnTime>
        </dfx:ATPShortageRequirement>
        <dfx:ATPShortageRequirement>
        <dfx:Product>
        <dfx:Item Value=“Cap1AltInt2”></dfx:Item>
        <dfx:ProductLevel Value=“RES”></dfx:ProductLevel>
        <dfx:ProductLocation Value=“Loc1”></dfx:ProductLocation>
        <dfx:WorkcenterName Value=“W1”></dfx:WorkcenterName>
        </dfx:Product>
        <dfx:Seller>
        <dfx:SellerName Value=“S1”></dfx:SellerName>
        <dfx:SellerLevel Value=“Level2”></dfx:SellerLevel>
        </dfx:Seller>
        <dfx:ATPBucket>
        <dfx:StartDate Value=“10/01/2007”></dfx:StartDate>
        <dfx:EndDate Value=“10/02/2007”></dfx:EndDate>
        </dfx:ATPBucket>
        <dfx:ShortageQty Value=“201”></dfx:ShortageQty>
        <dfx:OnTime Value=“TRUE”></dfx:OnTime>
        </dfx:ATPShortageRequirement>
        <dfx:ATPShortageRequirement>
        <dfx:Product>
        <dfx:Item Value=“Int1”></dfx:Item>
        <dfx:ProductLevel Value=“SKU”></dfx:ProductLevel>
        <dfx:ProductLocation Value=“Loc1”></dfx:ProductLocation>
        </dfx:Product>
        <dfx:Seller>
        <dfx:SellerName Value=“S1”></dfx:SellerName>
        <dfx:SellerLevel Value=“Level2”></dfx:SellerLevel>
        </dfx:Seller>
        <dfx:ATPBucket>
        <dfx:StartDate Value=“10/06/2007”></dfx:StartDate>
        <dfx:EndDate Value=“10/07/2007”></dfx:EndDate>
        </dfx:ATPBucket>
        <dfx:ShortageQty Value=“180”></dfx:ShortageQty>
        <dfx:OnTime Value=“TRUE”></dfx:OnTime>
        </dfx:ATPShortageRequirement>
        <dfx:ATPShortageRequirement>
        <dfx:Product>
        <dfx:Item Value=“Cap1FG1”></dfx:Item>
        <dfx:ProductLevel Value=“RES”></dfx:ProductLevel>
        <dfx:ProductLocation Value=“Loc1”></dfx:ProductLocation>
        <dfx:WorkcenterName Value=“W1”></dfx:WorkcenterName>
        </dfx:Product>
        <dfx:Seller>
        <dfx:SellerName Value=“S1”></dfx:SellerName>
        <dfx:SellerLevel Value=“Level2”></dfx:SellerLevel>
        </dfx:Seller>
        <dfx:ATPBucket>
        <dfx:StartDate Value=“10/06/2007”></dfx:StartDate>
        <dfx:EndDate Value=“10/07/2007”></dfx:EndDate>
        </dfx:ATPBucket>
        <dfx:ShortageQty Value=“180”></dfx:ShortageQty>
        <dfx:OnTime Value=“TRUE”></dfx:OnTime>
        </dfx:ATPShortageRequirement>
    </dfx:ATPShortageOption>
    <dfx:ATPShortageOption>
        <dfx:ATPShortageRequirement>
        <dfx:Product>
        <dfx:Item Value=“Int2”></dfx:Item>
        <dfx:ProductLevel Value=“SKU”></dfx:ProductLevel>
        <dfx:ProductLocation Value=“Loc1”></dfx:ProductLocation>
        </dfx:Product>
        <dfx:Seller>
        <dfx:SellerName Value=“S1”></dfx:SellerName>
        <dfx:SellerLevel Value=“Level2”></dfx:SellerLevel>
        </dfx:Seller>
        <dfx:ATPBucket>
        <dfx:StartDate Value=“10/06/2007”></dfx:StartDate>
        <dfx:EndDate Value=“10/07/2007”></dfx:EndDate>
        </dfx:ATPBucket>
        <dfx:ShortageQty Value=“180”></dfx:ShortageQty>
        <dfx:OnTime Value=“TRUE”></dfx:OnTime>
        </dfx:ATPShortageRequirement>
        <dfx:ATPShortageRequirement>
        <dfx:Product>
        <dfx:Item Value=“AltInt1”></dfx:Item>
        <dfx:ProductLevel Value=“SKU”></dfx:ProductLevel>
        <dfx:ProductLocation Value=“Loc1”></dfx:ProductLocation>
        </dfx:Product>
        <dfx:Seller>
        <dfx:SellerName Value=“S1”></dfx:SellerName>
        <dfx:SellerLevel Value=“Level2”></dfx:SellerLevel>
        </dfx:Seller>
        <dfx:ATPBucket>
        <dfx:StartDate Value=“10/06/2007”></dfx:StartDate>
        <dfx:EndDate Value=“10/07/2007”></dfx:EndDate>
        </dfx:ATPBucket>
        <dfx:ShortageQty Value=“180”></dfx:ShortageQty>
        <dfx:OnTime Value=“TRUE”></dfx:OnTime>
        </dfx:ATPShortageRequirement>
        <dfx:ATPShortageRequirement>
        <dfx:Product>
        <dfx:Item Value=“Cap1FG1”></dfx:Item>
        <dfx:ProductLevel Value=“RES”></dfx:ProductLevel>
        <dfx:ProductLocation Value=“Loc1”></dfx:ProductLocation>
        <dfx:WorkcenterName Value=“W1”></dfx:WorkcenterName>
        </dfx:Product>
        <dfx:Seller>
        <dfx:SellerName Value=“S1”></dfx:SellerName>
        <dfx:SellerLevel Value=“Level2”></dfx:SellerLevel>
        </dfx:Seller>
        <dfx:ATPBucket>
        <dfx:StartDate Value=“10/06/2007”></dfx:StartDate>
        <dfx:EndDate Value=“10/07/2007”></dfx:EndDate>
        </dfx:ATPBucket>
        <dfx:ShortageQty Value=“180”></dfx:ShortageQty>
        <dfx:OnTime Value=“TRUE”></dfx:OnTime>
        </dfx:ATPShortageRequirement>
    </dfx:ATPShortageOption>
    <dfx:ATPShortageOption>
        <dfx:ATPShortageRequirement>
        <dfx:Product>
        <dfx:Item Value=“AltInt2”></dfx:Item>
        <dfx:ProductLevel Value=“SKU”></dfx:ProductLevel>
        <dfx:ProductLocation Value=“Loc1”></dfx:ProductLocation>
        </dfx:Product>
        <dfx:Seller>
        <dfx:SellerName Value=“S1”></dfx:SellerName>
        <dfx:SellerLevel Value=“Level2”></dfx:SellerLevel>
        </dfx:Seller>
        <dfx:ATPBucket>
        <dfx:StartDate Value=“10/06/2007”></dfx:StartDate>
        <dfx:EndDate Value=“10/07/2007”></dfx:EndDate>
        </dfx:ATPBucket>
        <dfx:ShortageQty Value=“180”></dfx:ShortageQty>
        <dfx:OnTime Value=“TRUE”></dfx:OnTime>
        </dfx:ATPShortageRequirement>
        <dfx:ATPShortageRequirement>
        <dfx:Product>
        <dfx:Item Value=“AltInt1”></dfx:Item>
        <dfx:ProductLevel Value=“SKU”></dfx:ProductLevel>
        <dfx:ProductLocation Value=“Loc1”></dfx:ProductLocation>
        </dfx:Product>
        <dfx:Seller>
        <dfx:SellerName Value=“S1”></dfx:SellerName>
        <dfx:SellerLevel Value=“Level2”></dfx:SellerLevel>
        </dfx:Seller>
        <dfx:ATPBucket>
        <dfx:StartDate Value=“10/06/2007”></dfx:StartDate>
        <dfx:EndDate Value=“10/07/2007”></dfx:EndDate>
        </dfx:ATPBucket>
        <dfx:ShortageQty Value=“180”></dfx:ShortageQty>
        <dfx:OnTime Value=“TRUE”></dfx:OnTime>
        </dfx:ATPShortageRequirement>
        <dfx:ATPShortageRequirement>
        <dfx:Product>
        <dfx:Item Value=“Cap1FG1”></dfx:Item>
        <dfx:ProductLevel Value=“RES”></dfx:ProductLevel>
        <dfx:ProductLocation Value=“Loc1”></dfx:ProductLocation>
        <dfx:WorkcenterName Value=“W1”></dfx:WorkcenterName>
        </dfx:Product>
        <dfx:Seller>
        <dfx:SellerName Value=“S1”></dfx:SellerName>
        <dfx:SellerLevel Value=“Level2”></dfx:SellerLevel>
        </dfx:Seller>
        <dfx:ATPBucket>
        <dfx:StartDate Value=“10/06/2007”></dfx:StartDate>
        <dfx:EndDate Value=“10/07/2007”></dfx:EndDate>
        </dfx:ATPBucket>
        <dfx:ShortageQty Value=“180”></dfx:ShortageQty>
        <dfx:OnTime Value=“TRUE”></dfx:OnTime>
        </dfx:ATPShortageRequirement>
    </dfx:ATPShortageOption>
    <dfx:ATPShortageOption>
        <dfx:ATPShortageRequirement>
        <dfx:Product>
        <dfx:Item Value=“Comp4”></dfx:Item>
        <dfx:ProductLevel Value=“SKU”></dfx:ProductLevel>
        <dfx:ProductLocation Value=“Loc1”></dfx:ProductLocation>
        </dfx:Product>
        <dfx:Seller>
        <dfx:SellerName Value=“S1”></dfx:SellerName>
        <dfx:SellerLevel Value=“Level2”></dfx:SellerLevel>
        </dfx:Seller>
        <dfx:ATPBucket>
        <dfx:StartDate Value=“10/01/2007”></dfx:StartDate>
        <dfx:EndDate Value=“10/02/2007”></dfx:EndDate>
        </dfx:ATPBucket>
        <dfx:ShortageQty Value=“201”></dfx:ShortageQty>
        <dfx:OnTime Value=“TRUE”></dfx:OnTime>
        </dfx:ATPShortageRequirement>
        <dfx:ATPShortageRequirement>
        <dfx:Product>
        <dfx:Item Value=“Comp3”></dfx:Item>
        <dfx:ProductLevel Value=“SKU”></dfx:ProductLevel>
        <dfx:ProductLocation Value=“Loc1”></dfx:ProductLocation>
        </dfx:Product>
        <dfx:Seller>
        <dfx:SellerName Value=“S1”></dfx:SellerName>
        <dfx:SellerLevel Value=“Level2”></dfx:SellerLevel>
        </dfx:Seller>
        <dfx:ATPBucket>
        <dfx:StartDate Value=“10/01/2007”></dfx:StartDate>
        <dfx:EndDate Value=“10/02/2007”></dfx:EndDate>
        </dfx:ATPBucket>
        <dfx:ShortageQty Value=“201”></dfx:ShortageQty>
        <dfx:OnTime Value=“TRUE”></dfx:OnTime>
        </dfx:ATPShortageRequirement>
        <dfx:ATPShortageRequirement>
        <dfx:Product>
        <dfx:Item Value=“Cap1AltInt2”></dfx:Item>
        <dfx:ProductLevel Value=“RES”></dfx:ProductLevel>
        <dfx:ProductLocation Value=“Loc1”></dfx:ProductLocation>
        <dfx:WorkcenterName Value=“W1”></dfx:WorkcenterName>
        </dfx:Product>
        <dfx:Seller>
        <dfx:SellerName Value=“S1”></dfx:SellerName>
        <dfx:SellerLevel Value=“Level2”></dfx:SellerLevel>
        </dfx:Seller>
        <dfx:ATPBucket>
        <dfx:StartDate Value=“10/01/2007”></dfx:StartDate>
        <dfx:EndDate Value=“10/02/2007”></dfx:EndDate>
        </dfx:ATPBucket>
        <dfx:ShortageQty Value=“201”></dfx:ShortageQty>
        <dfx:OnTime Value=“TRUE”></dfx:OnTime>
        </dfx:ATPShortageRequirement>
        <dfx:ATPShortageRequirement>
        <dfx:Product>
        <dfx:Item Value=“AltInt1”></dfx:Item>
        <dfx:ProductLevel Value=“SKU”></dfx:ProductLevel>
        <dfx:ProductLocation Value=“Loc1”></dfx:ProductLocation>
        </dfx:Product>
        <dfx:Seller>
        <dfx:SellerName Value=“S1”></dfx:SellerName>
        <dfx:SellerLevel Value=“Level2”></dfx:SellerLevel>
        </dfx:Seller>
        <dfx:ATPBucket>
        <dfx:StartDate Value=“10/06/2007”></dfx:StartDate>
        <dfx:EndDate Value=“10/07/2007”></dfx:EndDate>
        </dfx:ATPBucket>
        <dfx:ShortageQty Value=“180”></dfx:ShortageQty>
        <dfx:OnTime Value=“TRUE”></dfx:OnTime>
        </dfx:ATPShortageRequirement>
        </dfx:ATPShortageRequirement>
        </dfx:Product>
        <dfx:Item Value=“Cap1FG1”></dfx:Item>
        <dfx:ProductLevel Value=“RES”></dfx:ProductLevel>
        <dfx:ProductLocation Value=“Loc1”></dfx:ProductLocation>
        <dfx:WorkcenterName Value=“W1”></dfx:WorkcenterName>
        </dfx:Product>
        <dfx:Seller>
        <dfx:SellerName Value=“S1”></dfx:SellerName>
        <dfx:SellerLevel Value=“Level2”></dfx:SellerLevel>
        </dfx:Seller>
        <dfx:ATPBucket>
        <dfx:StartDate Value=“10/06/2007”></dfx:StartDate>
        <dfx:EndDate Value=“10/07/2007”></dfx:EndDate>
        </dfx:ATPBucket>
        <dfx:ShortageQty Value=“180”></dfx:ShortageQty>
        <dfx:OnTime Value=“TRUE”></dfx:OnTime>
        </dfx:ATPShortageRequirement>
    </dfx:ATPShortageOption>
    </dfx:ATPReport>
    <dfx:StrategyStepName>
    <dfx:Value>REPORT_ATP_SHORTAGE</dfx:Value>
    </dfx:StrategyStepName>
    <dfx:PromiseInformation>
    <dfx:PromiseQuantityOnTime Value=“170”></
    dfx:PromiseQuantityOnTime>
    <dfx:PromiseQuantityLate Value=“0”></dfx:PromiseQuantityLate>
    <dfx:PromiseQuantityShort Value=“0”></dfx:PromiseQuantityShort>
    <dfx:LateDate Value=“----------”></dfx:LateDate>
    </dfx:PromiseInformation>
    </dfx:StrategyStepResult>
```

As shown above, the report ATP shortage step considers the ‘marked_buffer’ concept to reduce the number of options in CTP scenarios. Any product for which marked_buffer is set to ‘true’ is only considered to be available to procure more supply.

In this example, all the products are marked buffers and therefore demand fulfillment engines 212 provides all the possible options which can offer promise. As shown above, some ATP options which involve BOM of Int1 (e.g. an ATP option with Comp1, Comp2, Cap1Int1, Int2 and Cap1FG1) are not shown because on-time promise cannot be offered due to manufacturing lead time constraints. In addition, or as an alternative to this example, AltInt1, Int2 and AltInt2 are removed from the marked buffer's list and the report ATP shortage step is run. The ATP options are reduced to the following (ATP options 3, 4, 6, 7 and 8 shown above are eliminated):

Results: On_time_qty 170 late_qty 0 late_date -------- short_qty 0 ATP Option Number-1

Atp Qty Needed 170 For Product FG1::SKU::Loc1 on ATP Bucket Start Date 07-10-08 Is_On_Time TRUE

ATP Option Number-2

Atp Qty Needed 170 For Product Alt1FG1::SKU::Loc1 on ATP Bucket Start Date 07-10-08 Is_On_Time TRUE

ATP Option Number-3

Atp Qty Needed 201 For Product Comp4::SKU::Loc1 on ATP Bucket Start Date 07-10-01 Is_On_Time TRUE

Atp Qty Needed 201 For Product Comp3::SKU::Loc1 on ATP Bucket Start Date 07-10-01 Is_On_Time TRUE

Atp Qty Needed 201 For Product Cap1AltInt2:W1::RES::Loc1 on ATP Bucket Start Date 07-10-01 Is_On_Time TRUE

Atp Qty Needed 180 For Product Int1::SKU::Loc1 on ATP Bucket Start Date 07-10-06 Is_On_Time TRUE

Atp Qty Needed 180 For Product Cap1FG1:W1::RES::Loc1 on ATP Bucket Start Date 07-10-06 Is_On_Time TRUE

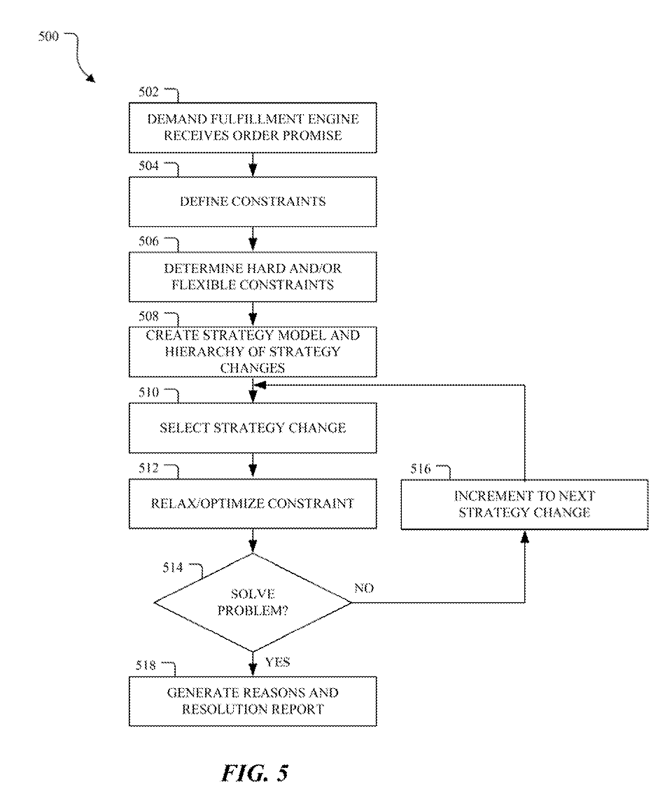

FIG. 5 illustrates an exemplary method 500 of determining constraints and resolution options to solve order promising exceptions. The method begins at step 502, where order promising system 110 receives an order promise from one or more enterprises 120a-120n or one or more customers 130a-130n. At step 504, order promising system 110 defines one or more supply chain constraints. As discussed above, demand fulfillment engines 212 or order promising system 110, may short or delay an order depending upon supply chain constraints. As an example only and not by way of limitation, the supply chain constraints include (but are not limited to) order quantity less than the minimum quantity that can be shipped, order quantity not in the multiples of the lot size of the shipment, order requested for delivery from specific location, and order requested for specific mode of transportation.

At step 506, order promising system 110 determines which of the above-defined constraints are hard constraints and may be non-negotiable and which of the above-defined constraints are flexible constraints. At step 508, order promising system 110 creates one or more strategy models. As discussed above, each strategy model 222 includes one or more strategy changes that one or more demand fulfillment engines 212 considers in a defined sequence. As an example only and not by way of limitation, order promising system 110 creates one or more strategy models through an OIL script. This may be done via the planning script itself since the strategy model is not required during import but only during the planning or the order promising time. For example, an exemplary OIL script is used to create a strategy model and an associated hierarchy of strategy changes in the strategy model:

define(MyStrategy, strategies.find or create(“TestStrategy”));

MyStrategy.set_description(“Test Strategy”);

MyStrategy.changes.find_or_create(“Relax_Min_Quantity”);

MyStrategy.changes.find_or_create(“Relax_Quote_Multiple”);

MyStrategy.changes.find_or_create(“Report_Allocation_Shortage”);

MyStrategy.changes.find_or_create(“Report_Atp_Shortage”);

Although an exemplary strategy model is shown and described; embodiments contemplate any number of strategy changes (as discussed above) in the strategy model, according to particular needs.

At step 510, order promising system 110 selects a strategy change from the defined sequence in the strategy model, created in step 508. Next at step 512, order promising system 110 and in particular, demand fulfillment engines 212 runs the selected strategy model and relaxes and optimizes the constraints, as discussed in detail above. At step 514, order promising system 110 determines if relaxing this constraint (optimizing constraint) solves the problem by providing a better promise. If not, the method proceeds to step 516, otherwise, the method proceeds to step 518. At step 516, demand fulfillment engines 212 increments to the next strategy change and then the method proceeds to step 510 to select the next strategy change from the defined sequence in the strategy model, created in step 508.

At step 518, demand fulfillment engines 212 generates a reasons and resolutions report (discussed below in more detail) and stores report data 226 in database 220 and the method ends. In addition, or as an alternative, one or more users associated with one or more enterprises 120a-120n and/or one or more customers 130a-130n may access report data 226. In addition, although, FIG. 5 illustrates one embodiment of a method of determining constraints and resolution options to solve order promising exceptions, various changes may be made to method 500 without departing from the scope of embodiments of the present invention.

FIG. 6 illustrates an exemplary method 600 of generating a reasons and resolutions report. The method begins at step 602, where demand fulfillment engines 212 creates a CreateOrder application programming interface (API). For example, the CreateOrder API promises, orders and returns the reasons for lateness and shortness, if the order was not promised completely on time. In addition, the CreateOrder API includes a tag, GiveReasonsReport, which controls whether or not demand fulfillment engines 212 calculates the reasons and a tag, ReasonsReportStrategy, which specifies the strategy name used to compute the Reasons and Resolution report.

At step 604, demand fulfillment engines 212 creates a GetReasonReport API, which gets the Reasons and Resolution report for an order that is already promised by demand fulfillment engines 212. The GetReasonReport API assumes that the order is not in report data 226 (memory) of database 220. In addition, the GetReasonReport API builds a UI workflow where users ma_{y} change some supply and allocation problems and then invoke the Reasons and Resolution report again to see the impact.

In one embodiment, the GetReasonReport API is read-only, so, for example, the changes done by this API to compute the new Reasons and Resolution report are not persisted in demand fulfillment engines 212. In addition, or as an alternative, the GetReasonReport API takes the name of the strategy, any supply and/or allocation changes and a list of complete order structures (since demand fulfillment engines 212 does not have the order in report data 226, this API needs the complete order and its peggings). In addition, demand fulfillment engines 212 returns the promises that the orders could get after applying the supply and/or allocation changes, and the reasons for shortness and lateness, if any. Furthermore, the promises of the orders are for reporting purpose only and they are not persisted into demand fulfillment engines 212.

At step 606, demand fulfillment engines 212 creates a GetBatchReasonReport API which serves the same function as GetReasonsReport API and is used where demand fulfillment engines 212 has the orders in report data 226 (in allocation planning or batch order promising scenarios). In addition, the order ID's are enough to get the report, instead of the complete orders and their peggings.

At step 608, demand fulfillment engines 212 creates a multiple API which in the context of Reasons and Resolution report, commits the changes to demand fulfillment engines 212. The GetReasonReport API provides evaluation options and the supply and allocation changes required to promise the order. Demand fulfillment engines 212 uses the multiple API to make the final change, once the changes are known and the changes are persisted. For example, it has multiple inputs:

1. Move Allocation information

2. Update supply information

3. Complete order structure and promise details

Output of this API contains new promise information with all the changes being committed to demand fulfillment engines 212.

In one embodiment, a generic context Multiple API can include any combination of APIs supported by demand fulfillment engines 212, as given below:
1. Generating Order Management report—this takes either one of these inputs:
   a. Order details—OM report for all these orders
   b. Consumed forecast details—OM report for all the orders which have consumed from this forecast.
   c. Consumed ATP details—OM report for all the orders which have consumed from this ATP.
2. Generating Allocation Management report—product, seller and start/end dates as input.
3. Generating Supply Management report—product, seller and start/end dates as input.
4. Cancelling orders—takes
5. Update Supply—product, seller, ATP buckets and quantities as input. Note that the supply is updated at the root seller and allocations are given to the seller provided in input.
6. Move Allocations—product, sellers, forecast bucket and increase/decrease quantities as input.
7. Re-promise the orders—order structure and promise details as input.
8. Create new orders—order structure as input.

At step 610, demand fulfillment engines 212 creates a BatchMultiple API which serves the same function as Multiple API and is used where demand fulfillment engines 212 has the orders in the report data 226. Since a batch demand fulfillment engines 212 reads all the orders from database 220, the batch multiple API doesn't create the new orders in demand fulfillment engines 212.

Although, FIG. 6 illustrates one embodiment of a method of generating a reasons and resolutions report, various changes may be made to method 600 without departing from the scope of embodiments of the present invention.

Reference in the foregoing specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the exemplary embodiments of the present invention have been shown and described, it will be understood that various changes and modifications to the foregoing embodiments may become apparent to those skilled in the art without departing from the spirit and scope of embodiments of the present invention. Accordingly, the invention is not limited to the embodiments disclosed, but is capable of numerous rearrangements, modification and substitutions without departing form the spirit and scope of the present invention.

What is claimed is:

1. A computer-implemented order promising system, comprising:
a database storing order promise data associated with one or more enterprises;
a computer coupled with the database, the computer configured to:
receive an order promise from the one or more enterprises;
define one or more constraints;
create one or more strategy models comprising one or more strategy changes;
execute the one or more strategy models to relax the one or more constraints using the one or more strategy changes; and
generate a report of the reasons for lateness and shortness of the order promise and store the generated report in the database.

2. The system of claim 1, wherein the one or more constraints are selected from the group consisting of order quantity less than the minimum quantity that can be shipped, order quantity not in the multiples of the lot size of the shipment, order requested for delivery from specific location, and order requested for specific mode of transportation.

3. The system of claim 1, wherein the computer is further configured to determine if any of the one or more constraints are hard constraints.

4. The system of claim 1, wherein the computer is further configured to determine if any of the one or more constraints are flexible constraints.

5. The system of claim 1, wherein the one or more strategy changes are selected from the group consisting of:
relax minimum quantity;
relax quote multiple;
relax pick pack time;
relax maximum edges;
relax permitted delivery zones;
relax permitted delivery sources;
relax permitted delivery services;
relax permitted matching products;
report allocation shortage; and
report available-to-promise shortage.

6. The system of claim 1, wherein the computer is further configured to access the generated report for an order that is already promised by the order promising system.

7. The system of claim 1, wherein the computer is further configured to commit the one or more strategy changes to the order promising system.

8. A computer-implemented method providing an order promising system, comprising:
receiving, by a computer, an order promise from one or more enterprises;
defining, by the computer, one or more constraints;
creating, by the computer, one or more strategy models comprising one or more strategy changes;
executing, by the computer, the one or more strategy models to relax the one or more constraints using the one or more strategy changes; and
generating, by the computer, a report of the reasons for lateness and shortness of the order promise and store the generated report.

9. The method of claim 8, wherein the one or more constraints are selected from the group consisting of order quantity less than the minimum quantity that can be shipped, order quantity not in the multiples of the lot size of the shipment, order requested for delivery from specific location, and order requested for specific mode of transportation.

10. The method of claim 8, further comprising determining if any of the one or more constraints are hard constraints.

11. The method of claim 8, further comprising determining if any of the one or more constraints are flexible constraints.

12. The method of claim 8, wherein the one or more strategy changes are selected from the group consisting of:
relax minimum quantity;
relax quote multiple;
relax pick pack time;
relax maximum edges;
relax permitted delivery zones;
relax permitted delivery sources;
relax permitted delivery services;
relax permitted matching products;
report allocation shortage; and
report available-to-promise shortage.

13. The method of claim 8, further comprising accessing the generated report for an order that is already promised by the order promising system.

14. The method of claim 8, further comprising committing the one or more strategy changes to the order promising system.

15. A computer-readable medium embodied with software enabling an order promising system, the software when executed using one or more computers is configured to:
receive an order promise from one or more enterprises;
define one or more constraints;
create one or more strategy models comprising one or more strategy changes;
execute the one or more strategy models to relax the one or more constraints using the one or more strategy changes; and
generate a report of the reasons for lateness and shortness of the order promise and store the generated report.

16. The computer-readable medium of claim 15, wherein the one or more constraints are selected from the group consisting of order quantity less than the minimum quantity that can be shipped, order quantity not in the multiples of the lot size of the shipment, order requested for delivery from specific location, and order requested for specific mode of transportation.

17. The computer-readable medium of claim 15, wherein the software is further configured to determine if any of the one or more constraints are hard constraints.

18. The computer-readable medium of claim 15, wherein the software is further configured to determine if any of the one or more constraints are flexible constraints.

19. The computer-readable medium of claim 15, wherein the one or more strategy changes are selected from the group consisting of:
relax minimum quantity;
relax quote multiple;
relax pick pack time;
relax maximum edges;
relax permitted delivery zones;
relax permitted delivery sources;
relax permitted delivery services;
relax permitted matching products;
report allocation shortage; and
report available-to-promise shortage.

20. The computer-readable medium of claim 15, wherein the software is further configured to access the generated report for an order that is already promised by the order promising system.

21. The computer-readable medium of claim 15, wherein the software is further configured to commit the one or more strategy changes to the order promising system.
